(19) United States
(12) Patent Application Publication
(10) Pub. No.: US 2026/0350997 A1
(43) Pub. Date: Nov. 5, 2026

(54) SYSTEMS, DEVICES, AND METHODS FOR DETECTING ROAD HAZARDS

(71) Applicants: Siddhi Singh, Highlands Ranch, CO (US); Gabriana Scoville, Littleton, CO (US); Robyn Ballheim, Littleton, CO (US); Dhriti Sinha, Parker, CO (US); Tylor Chacon, Lakewood, CO (US)

(72) Inventors: Siddhi Singh, Highlands Ranch, CO (US); Gabriana Scoville, Littleton, CO (US); Robyn Ballheim, Littleton, CO (US); Dhriti Sinha, Parker, CO (US); Tylor Chacon, Lakewood, CO (US)

(21) Appl. No.: 19/196,208

(22) Filed: May 1, 2025

(51) Int. Cl. G06V 20/52; G01J 5/00; G01J 5/08

(52) U.S. Cl. CPC G06V 20/52; G01J 5/0025; G01J 5/0859; G01J 2005/0077

(57) ABSTRACT

In some aspects, the present disclosure provides a device. The device can comprise a thermal imaging camera comprising a field of view. The device can comprise a processor comprising computer-executable instructions configured to: process, using a neural network, a plurality of images obtained from the thermal imaging camera to detect an animal within the field of view; and generate an alert signal indicating that the animal was detected.

### BACKGROUND

The present disclosure relates to systems, devices, and methods for detecting road hazards, e.g., animals.

### SUMMARY

In some aspects, the present disclosure provides systems, devices, and methods for searching for road hazards and alerting a user (e.g., a driver of a vehicle) if a road hazard is found. The device can be installed or mounted to a vehicle, e.g., within the cabin or outside of the vehicle. Once installed, the device can scan for animals in the direction that the device is pointing to, while the vehicle is in motion. The device can function independently of onboard vehicle systems. The device can be, e.g., pointed towards the front of the vehicle such that the driver of the vehicle can be warned by the device before the vehicle reaches a position in front of the vehicle.

The device can use a neural network. The neural network can be trained to identify wildlife in images taken by a camera of the device. If an animal is detected, an alert signal can be generated by the device (e.g., light or sound) so that the driver of the vehicle may react to avoid such wildlife.

The images provided to the neural network can be thermal images. While visible light is abundant, the appearance of certain animals are adapted to its environment such that it is camouflaged. For example, the orange and brown coats of deer may blend into a backdrop of rock and stone comprising iron oxide, which can make it difficult for humans and neural networks alike to detect the deer based solely on color. Moreover, visible light is less available in the night. Moreover, color can be obstructed when the weather is raining. Therefore, thermal imaging can provide a modality that is more sensitive to various environmental light conditions.

The neural network can be implemented locally on the device. For example, the neural network can be loaded into a memory of a process of the device (e.g., a memory of a GPU or a CPU). The neural network can stay loaded in memory continuously while the device is functioning, so that computational time involved in repeatedly loading the neural network into memory can be saved.

In some aspects, the present disclosure provides a device comprising: a thermal imaging camera comprising a field of view; a processor comprising computer-executable instructions configured to: i. process, using a neural network, a plurality of images obtained from the thermal imaging camera to detect an animal within the field of view; and ii. generate an alert signal indicating that the animal was detected.

In some embodiments, the thermal imaging camera is configured to detect infrared radiation. In some embodiments, the thermal imaging camera is configured to detect light having wavelengths of at least 780 nm, 800 nm, 850 nm, 900 nm, 950 nm, 1 μm, 5 μm, 10 μm, 50 μm, 100 μm, or 500 μm. In some embodiments, the thermal imaging camera is configured to detect light having wavelengths of at most 800 nm, 850 nm, 900 nm, 950 nm, 1 μm, 5 μm, 10 μm, 50 μm, 100 μm, 500 μm, or 1 mm.

In some aspects, the present disclosure provides a device comprising: a first camera comprising a first field of view; a second camera comprising a second field of view; a processor comprising computer-executable instructions configured to: i. process, using one or more neural networks, a first image from the first field of view of the first camera and a second image from the second field of view of the second camera to detect an animal; ii. determine a position of the animal relative to the device based on the first image and the second image; and iii. generate an alert signal indicating that the animal was detected.

In some embodiments, the first camera and the second camera are configured with different focal lengths. In some embodiments, the position of the animal is determined based on the different focal lengths. In some embodiments, the first camera and the second camera are configured to detect different wavelengths of light. In some embodiments, the first camera is a thermal imaging camera. In some embodiments, the second camera have is a visible light camera. In some embodiments, the computer-executable instructions are further configured to convert a first video data from the first camera into a first plurality of images comprising the first image. In some embodiments, the computer-executable instructions are further configured to convert a second video data from the second camera into a first plurality of images comprising the second image. In some embodiments, the computer-executable instructions are further configured to align the first plurality of images and the second plurality of images in time. In some embodiments, the one or more neural networks comprises a first neural network configured to process the first plurality of images. In some embodiments, the one or more neural networks comprises a second neural network configured to process the second plurality of images. In some embodiments, the first camera and the second camera are configured with the same focal length. In some embodiments, the position of the animal is determined using parallax based on a first position of the first camera and a second position of the second camera. In some embodiments, the first camera and the second camera are configured to detect the same wavelengths of light. In some embodiments, the first camera and the second camera are both a thermal imaging camera.

In some aspects, the present disclosure provides a device comprising: a camera comprising a field of view; a processor comprising computer-executable instructions configured to: i. process, using a neural network, a plurality of images obtained from the camera to detect an animal within the field of view; and ii. generate an alert signal indicating that the animal was detected, wherein the device is configured to delete images in 60 seconds or less.

In some embodiments, the processor is configured to delete images in 30, 15, 10, 5, or 3 seconds or less. In some embodiments, the neural network is contained within the device. In some embodiments, the neural network is on the cloud.

In some aspects, the present disclosure provides a device comprising: a camera comprising a field of view; a processor comprising computer-executable instructions configured to: i. process, using a neural network, a plurality of images obtained from the camera to detect an animal within the field of view; ii. determine a first trajectory of the animal and a second trajectory of the device; iii. predict a potential collision based on a first trajectory and the second trajectory; and iv. generate an alert signal indicating the potential collision.

In some embodiments, the device further comprises a mount configured to affix the device within a cabin of a vehicle. In some embodiments, the device comprises a footprint of less than 50, 40, 30, 20, 10, or 5 cm². In some embodiments, the device comprises a volume of less than 100, 80, 70, 60, 50, 40, 30, 20, or 10 cm³. In some embodiments, the device does not comprise a touchscreen. In some embodiments, the device further comprises an external power source. In some embodiments, the device further comprises an internal power source. In some embodiments, the device further comprises comprising a battery. In some embodiments, the battery is a lithium-ion battery. In some embodiments, the battery is a lithium metal battery. In some embodiments, the processor comprises a graphical processing unit. In some embodiments, the processor comprises a central processing unit. In some embodiments, the processor comprises firmware configured to perform hardware acceleration.

In some embodiments, the computer-executable instructions further comprise a crash sequence that autonomously runs when the computer-executable instructions crash. In some embodiments, the computer-executable instructions further comprise a boot sequence that autonomously runs when the device is turned on. In some embodiments, the computer-executable instructions further comprise a power saving sequence configured to: a. detect that a vehicle that the device is mounted to is not running or not moving; and b. reduce power consumption of the device. In some embodiments, the computer-executable instructions are further configured to convert video data into the plurality of images. In some embodiments, the computer-executable instructions are further configured to resize, normalize, or noise filter the plurality of images.

In some embodiments, the neural network is coded in a low-level language. In some embodiments, the low-level language is C++ or C. In some embodiments, the neural network comprises a convolutional neural network. In some embodiments, the neural network detects the animal with an accuracy of at least 70, 80, 90, 95, 96, 97, 98, 99, 99.1, 99.2, 99.3, 99.4, 99.5, 99.6, 99.7, 99.8, or 99.9 percent. In some embodiments, the computer-executable instructions are further configured to: a. divide up each image in the plurality of images into a grid of tiles; b. predict a bounding box of the animal based on the grid of tiles; and c. predict a class probability of the animal based on the bounding box. In some embodiments, the neural network is trained to detect the animal using a training dataset of images comprising: a. training images taken during day, night, dawn, dusk, or any combination thereof; and b. training images taken during rain, snow, hail, fog, storm, sunny weather, cloudy weather, or any combination thereof. In some embodiments, the neural network is configured to detect the animal in less than 5000, 4000, 3000, 2000, 1000, 500, 400, 300, 200, 100, 50, 40, 30, 20, or 10 milliseconds when the animal is within 100, 90, 80, 70, 60, 50, 40, 30, 20, or 10 feet of the device. In some embodiments, the plurality of images are processed using an ensemble of neural networks. In some embodiments, the ensemble of neural networks provide different predictions. In some embodiments, the computer-executable instructions are further configured to detect the animal based on a consensus between the ensemble of neural networks. In some embodiments, the computer-executable instructions are configured to detect the animal without requiring on a GPS signal. In some embodiments, the computer-executable instructions are configured to detect the animal continuously without disabling detection based on a location of device.

In some embodiments, the plurality of images are obtained a rate of at least 1, 2, 3, 4, 5, 6, 7, 8, 9, 10, 20, 30, 40, 50, 60, 80, 90, or 100 times per second. In some embodiments, the camera comprise a resolution of 100, 200, 300, 400, 500, 1000, 2000, 3000, 4000, or 5000 pixels in a first dimension and 100, 200, 300, 400, 500, 1000, 2000, 3000, 4000, or 5000 pixels in a second dimension. In some embodiments, the device further comprises a lidar or a radar. In some embodiments, the computer-executable instructions are further configured to detect a road hazard comprising a tree, a boulder, a bicyclist, or any combination thereof.

In some embodiments, the animal is a deer, a possum, a dog, a cat, a cow, a squirrel, a rabbit, a skunk, a raccoon. In some embodiments, the neural network is configured to detect a deer, a possum, a dog, a cat, a cow, a squirrel, a rabbit, a skunk, a raccoon, or any combination thereof.

In some embodiments, the alert signal comprises light, audio, or both. In some embodiments, the alert signal comprises an LED light. In some embodiments, the LED light is red, yellow, or green. In some embodiments, the LED light is a strip or a single LED. In some embodiments, the alert signal is directional to indicate a direction that the animal is detected in. In some embodiments, an intensity of the alert signal varies based on risk of collision, proximity to the animal, or both. In some embodiments, the alert signal comprises a light that blinks with higher frequency when the risk of collision is high or the animal is close compared to when the risk of collision is low or the animal is far. In some embodiments, the alert signal comprises a sound that is louder when the risk of collision is high or the animal is close compared to when the risk of collision is low or the animal is far. In some embodiments, the alert signal comprises a sound that beeps with higher frequency when the risk of collision is high or the animal is close compared to when the risk of collision is low or the animal is far.

In some aspects, the present disclosure provides a device comprising: a thermal imaging camera comprising a field of view; a processor comprising computer-executable instructions configured to: i. process, using a neural network, a plurality of images obtained from the thermal imaging camera to detect an animal within the field of view; and ii. generate an alert signal indicating that the animal was detected.

In some embodiments, the device further comprises a mount configured to affix the device within a cabin of a vehicle. In some embodiments, the device comprises a footprint of less than 10 cm². In some embodiments, the computer-executable instructions are configured to determine a position of the animal relative to the device based on the first image and the second image. In some embodiments, the device is configured to delete images in 60 seconds or less. In some embodiments, the processor comprises a graphical processing unit.

In some embodiments, the neural network is coded in a low-level language. In some embodiments, the neural network detects the animal with an accuracy of at least 90 percent. In some embodiments, the neural network is trained to detect the animal using a training dataset of images comprising: a. training images taken during day, night, dawn, dusk, or any combination thereof; and b. training images taken during rain, snow, hail, fog, storm, sunny weather, cloudy weather, or any combination thereof. In some embodiments, the neural network is configured to detect the animal in less than 500 milliseconds when the animal is within 50 feet of the device. In some embodiments, the plurality of images are obtained a rate of at least 5 times per second.

In some embodiments, the computer-executable instructions are configured to process, using an ensemble of neural networks comprising the neural network, the plurality of images obtained from the thermal imaging camera to detect the animal within the field of view. In some embodiments, the neural network is configured to detect a deer, a possum, a dog, a cat, a cow, a squirrel, a rabbit, a skunk, a raccoon, or any combination thereof.

In some embodiments, the alert signal comprises light, audio, or both. In some embodiments, the alert signal comprises an LED light. In some embodiments, the LED light is red, yellow, or green. In some embodiments, an intensity of the alert signal varies based on risk of collision, proximity to the animal, or both.

In some embodiments, the device further comprising a second camera comprising a second field of view, wherein a second plurality images obtained from the second camera in the second field of view is used to detect the animal. In some embodiments, the second plurality images is used to determine a position of the animal relative to the device. In some embodiments, the second camera detects different wavelengths from the thermal imaging camera, or wherein the second camera comprises a different focal point from the thermal imaging camera.

In some aspects, the present disclosure provides a computer-implemented method, comprising: training a neural network model to process a plurality of images obtained from a thermal imaging camera mounted to a vehicle to detect an animal within a field of view of the thermal imaging camera and generate an alert signal indicating that the animal was detected.

In some aspects, the present disclosure provides a non-transitory computer-readable storage media encoded with a computer program including instructions executable by one or more processors to implement any one of the computer-implemented methods or computer-implemented systems disclosed herein.

In some aspects, the present disclosure provides a computer-implemented system comprising: (a) a digital processing device comprising: (b) at least one processor, an operating system configured to perform executable instructions, a memory, and a computer program including instructions executable by the digital processing device to perform any one of the computer-implemented methods or computer-implemented systems disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure.

Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a method for detecting an animal using image data from one or more cameras, in accordance with some embodiments.

FIG. 2 shows different methods of determining distance of an animal from the device, in accordance with some embodiments.

FIG. 3 shows an example of image detection using posture estimation, in accordance with some embodiments.

FIG. 4 shows an alert signal displayed through a screen when an animal is detected in close proximity to the vehicle.

FIG. 5 shows a decision-model for generating or not generating an alert signal when an animal is detected, in accordance with some embodiments.

FIG. 6 shows a decision-model for generating or not generating an alert signal when an animal is detected, in accordance with some embodiments.

FIG. 7 shows components of the device, in accordance with some embodiments.

FIG. 8 shows a device affixed to the dashboard and behind the rearview mirror of a vehicle, in accordance with some embodiments.

FIG. 9 shows a computer, in accordance with some embodiments.

FIG. 10 shows the device. The top panel shows the device while it is not powered. The bottom panel shows the device outputting an alert signal, in accordance with some embodiments.

FIG. 11 shows an example of an input image labeled with annotated bounding boxes for animal detection by the neural network, in accordance with some embodiments.

FIG. 12 shows an example of a thermal image (top), an optical image (middle), and trajectory estimation (bottom), in accordance with some embodiments.

### DETAILED DESCRIPTION

In some aspects, the present disclosure provides systems, devices, and methods for searching for road hazards and alerting a user (e.g., a driver of a vehicle) if a road hazard is found. The device can be installed or mounted to a vehicle, e.g., within the cabin or outside of the vehicle. Once installed, the device can scan for animals in the direction that the device is pointing to, while the vehicle is in motion. The device can function independently of onboard vehicle systems. The device can be, e.g., pointed towards the front of the vehicle such that the driver of the vehicle can be warned by the device before the vehicle reaches a position in front of the vehicle.

The device can use a neural network. The neural network can be trained to identify wildlife in images taken by a camera of the device. If an animal is detected, an alert signal can be generated by the device (e.g., light or sound) so that the driver of the vehicle may react to avoid such wildlife.

The images provided to the neural network can be thermal images. While visible light is abundant, the appearance of certain animals are adapted to its environment such that it is camouflaged. For example, the orange and brown coats of deer may blend into a backdrop of rock and stone comprising iron oxide, which can make it difficult for humans and neural networks alike to detect the deer based solely on color. Moreover, visible light is less available in the night. Moreover, color can be obstructed when the weather is raining. Therefore, thermal imaging can provide a modality that is more sensitive to various environmental light conditions.

The neural network can be implemented locally on the device. For example, the neural network can be loaded into a memory of a process of the device (e.g., a memory of a GPU or a CPU). The neural network can stay loaded in memory continuously while the device is functioning, so that computational time involved in repeatedly loading the neural network into memory can be saved.

Various alert signals are contemplated herein. Light and/or audio can be used to generate an alert signal for the user. The user may customize the alert signal to change the brightness of the light or the decibels of the audio.

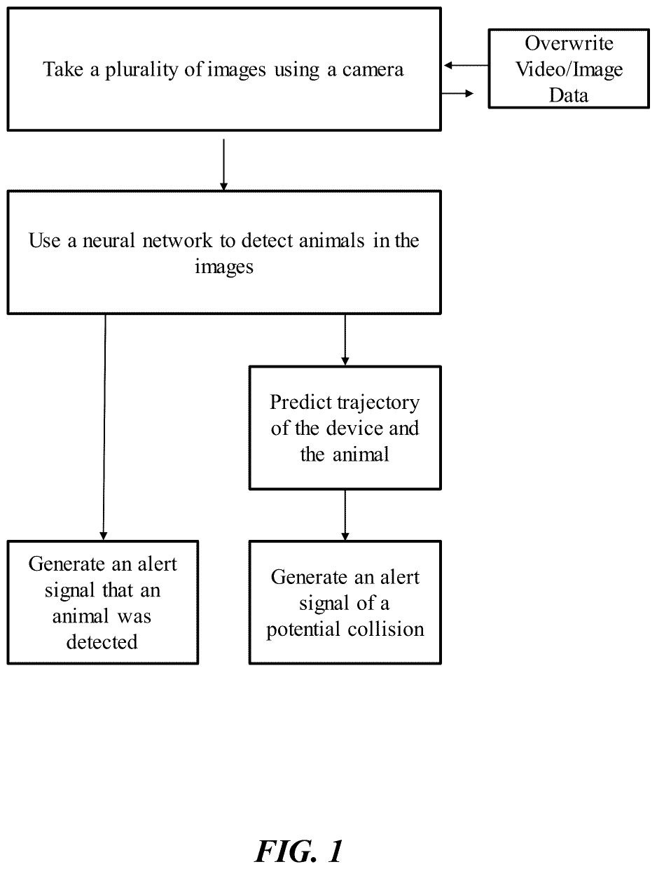

In some aspects, the present disclosure provides a device. FIG. 1 shows a method for detecting an animal using image data from one or more cameras, in accordance with some embodiments. In some embodiments, the device comprises a thermal imaging camera. In some embodiments, the thermal imaging camera comprises a field of view. In some embodiments, the device comprises a processor. In some embodiments, the processor comprises computer-executable instructions. In some embodiments, the computer-executable instructions are configured to process, using a neural network, a plurality of images obtained from the thermal imaging camera to detect an animal within the field of view. In some embodiments, the computer-executable instructions are configured to process generate an alert signal indicating that the animal was detected.

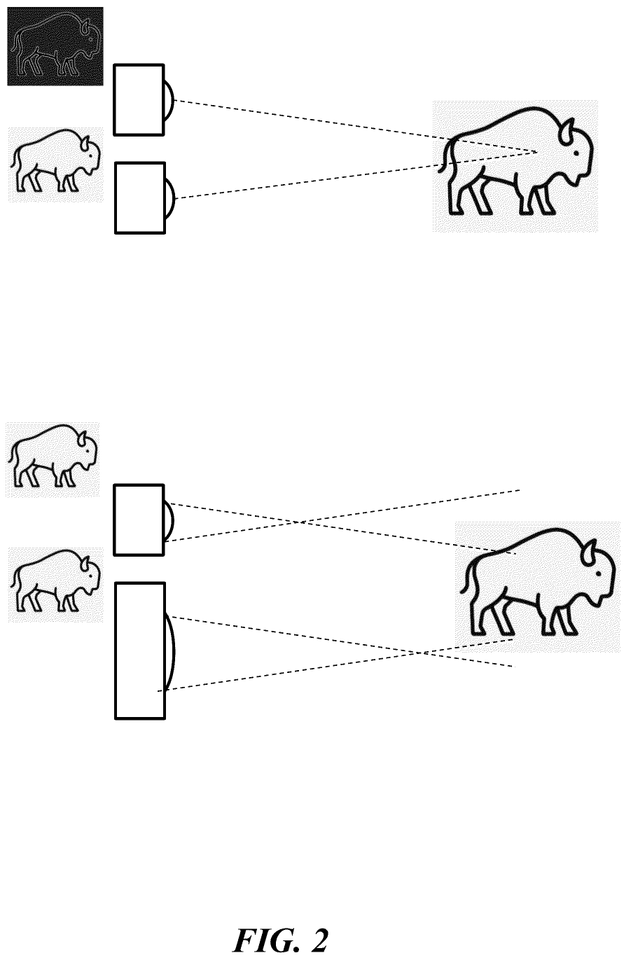

In some aspects, the present disclosure provides a device. In some embodiments, the device can determine distance of an animal from the device. FIG. 2 shows different methods of determining distance of an animal from the device, in accordance with some embodiments. In some embodiments, the device comprises a first camera comprising a first field of view. In some embodiments, the device comprises a second camera comprising a second field of view. In some embodiments, the device comprises a processor. In some embodiments, the processor comprises computer-executable instructions. In some embodiments, the computer-executable instructions are configured to process, using one or more neural networks, a first image from the first field of view of the first camera and a second image from the second field of view of the second camera to detect an animal. In some embodiments, the computer-executable instructions are configured to determine a position of the animal relative to the device based on the first image and the second image. In some embodiments, the computer-executable instructions are configured to generate an alert signal indicating that the animal was detected.

In some aspects, the present disclosure provides a device. In some embodiments, the device can determine the trajectory of an animal, the device, or both. In some embodiments, the device comprises a camera comprising a field of view. In some embodiments, the device comprises a processor. In some embodiments, the processor comprises computer-executable instructions. In some embodiments, the computer-executable instructions are configured to process, using a neural network, a plurality of images obtained from the camera to detect an animal within the field of view. In some embodiments, the computer-executable instructions are configured to determine a first trajectory of the animal and a second trajectory of the device. In some embodiments, the computer-executable instructions are configured to detect a direction that the animal is facing in. In some embodiments, the computer-executable instructions are configured to detect a road, e.g., a road span, a road shape, or both. In some embodiments, the computer-executable instructions are configured to predict a potential collision based on a first trajectory and the second trajectory. In some embodiments, the computer-executable instructions are configured to generate an alert signal indicating the potential collision.

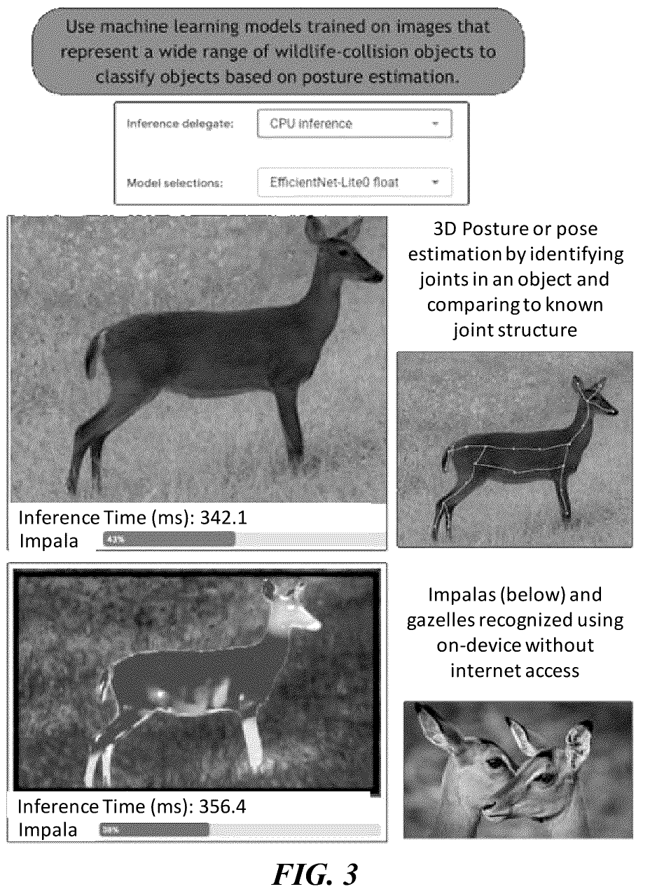

In some embodiments, the neural network can use posture or pose estimation to detect an animal. In some embodiments, the neural network can use posture or pose estimation detect an orientation of the animal. In some embodiments, the neural network can use posture or pose estimation to predict a trajectory of the animal. FIG. 3 shows an example of image detection using posture estimation. The neural network is able to detect animals in less than 350 ms.

In some embodiments, the device can be configured to continuously detect wildlife without disabling detection based on location. For example, the device can be configured to effectively operate in an urban, suburban, or rural settings. In some embodiments, the device can be configured to detect an animal that is in motion. In some embodiments, the device can be configured to alert a user without controlling the vehicle, e.g., braking or steering the vehicle. Full control of the vehicle may remain with the driver.

In some embodiments, the device can detect animals without using lidar or radar components and systems, which may provide a lighter-weight, and computationally faster real-time image processing for direct driver alerts. A lidar can be used to provide depth and/or distance sensing. A radar can be used to provide motion detection. In some embodiments, a lidar may provide improved animal detection in poor visibility conditions. A combination of multiple detector/camera systems can provide enhanced detection accuracy, especially in poor weather/visibility conditions.

In some embodiments, the device can be configured not to share data externally (e.g., with the cloud, or more generally, a data server). In some embodiments, the device can be configured to performed networked detection relying on a plurality of devices.

### Cameras and Sensors

In some embodiments, a camera is a thermal imaging camera. In some embodiments, the thermal imaging camera is configured to detect infrared radiation. In some embodiments, the thermal imaging camera is configured to detect light having wavelengths of at least 780 nm, 800 nm, 850 nm, 900 nm, 950 nm, 1 μm, 5 μm, 10 μm, 50 μm, 100 μm, or 500 μm. In some embodiments, the thermal imaging camera is configured to detect light having wavelengths of at most 800 nm, 850 nm, 900 nm, 950 nm, 1 μm, 5 μm, 10 μm, 50 μm, 100 μm, 500 μm, or 1 mm.

In some embodiments, the device comprises 1, 2, 3, 4, or more cameras. In some embodiments, a first camera and a second camera are configured with different focal lengths. In some embodiments, the position of the animal is determined based on the different focal lengths. In some embodiments, a first camera and a second camera are configured to detect different wavelengths of light. In some embodiments, the first camera is a thermal imaging camera. In some embodiments, the second camera have is a visible light camera.

In some embodiments, the computer-executable instructions are further configured to convert a first video data from the first camera into a first plurality of images comprising the first image. In some embodiments, the computer-executable instructions are further configured to convert a second video data from the second camera into a second plurality of images comprising the second image. In some embodiments, the computer-executable instructions are further configured to align the first plurality of images and the second plurality of images in time. In some embodiments, the one or more neural networks comprises a first neural network configured to process the first plurality of images. In some embodiments, the one or more neural networks comprises a second neural network configured to process the second plurality of images.

In some embodiments, a first camera and a second camera are configured with the same focal length. In some embodiments, the position of the animal is determined using parallax based on a first position of the first camera and a second position of the second camera.

In some embodiments, a first camera and a second camera are configured to detect the same wavelengths of light. In some embodiments, the first camera and the second camera are both a thermal imaging camera.

In some embodiments, the plurality of images are obtained a rate of at least 1, 2, 3, 4, 5, 6, 7, 8, 9, 10, 20, 30, 40, 50, 60, 80, 90, or 100 times per second.

In some embodiments, a camera comprises a resolution of 100, 200, 300, 400, 500, 1000, 2000, 3000, 4000, or 5000 pixels in a first dimension and 100, 200, 300, 400, 500, 1000, 2000, 3000, 4000, or 5000 pixels in a second dimension.

### Artificial Intelligence

In some embodiments, the neural network is coded in a low-level language. In some embodiments, the low-level language is C++ or C. In some embodiments, the neural network comprises a convolutional neural network. In some embodiments, the neural network detects the animal with an accuracy of at least 70, 80, 90, 95, 96, 97, 98, 99, 99.1, 99.2, 99.3, 99.4, 99.5, 99.6, 99.7, 99.8, or 99.9 percent. In some embodiments, the neural network detects the animal with an accuracy of at most 70, 80, 90, 95, 96, 97, 98, 99, 99.1, 99.2, 99.3, 99.4, 99.5, 99.6, 99.7, 99.8, or 99.9 percent. In some embodiments, the computer-executable instructions are configured to divide up each image in the plurality of images into a grid of tiles. In some embodiments, the computer-executable instructions are configured to predict a bounding box of the animal based on the grid of tiles. In some embodiments, the computer-executable instructions are further configured to predict a class probability of the animal based on the bounding box.

In some embodiments, the neural network is trained to detect the animal using a training dataset of images. In some embodiments, the training dataset of images comprises training images taken during day, night, dawn, dusk, or any combination thereof. In some embodiments, the training dataset of images comprises training images taken during rain, snow, hail, fog, storm, sunny weather, cloudy weather, or any combination thereof.

In some embodiments, the neural network is configured to detect the animal in less than 5000, 4000, 3000, 2000, 1000, 500, 400, 300, 200, 100, 50, 40, 30, 20, or 10 milliseconds when the animal is within 100, 90, 80, 70, 60, 50, 40, 30, 20, or 10 feet of the device. In some embodiments, the neural network is configured to detect the animal in more than 5000, 4000, 3000, 2000, 1000, 500, 400, 300, 200, 100, 50, 40, 30, 20, or 10 milliseconds when the animal is within 100, 90, 80, 70, 60, 50, 40, 30, 20, or 10 feet of the device.

In some embodiments, the plurality of images are processed using an ensemble of neural networks. In some embodiments, the ensemble of neural networks provide different predictions. In some embodiments, the computer-executable instructions are further configured to detect the animal based on a consensus between the ensemble of neural networks.

In some embodiments, the computer-executable instructions are configured to detect the animal without requiring on a GPS signal.

In some embodiments, the computer-executable instructions are configured to detect the animal continuously without disabling detection based on a location of device.

### Alert Signal

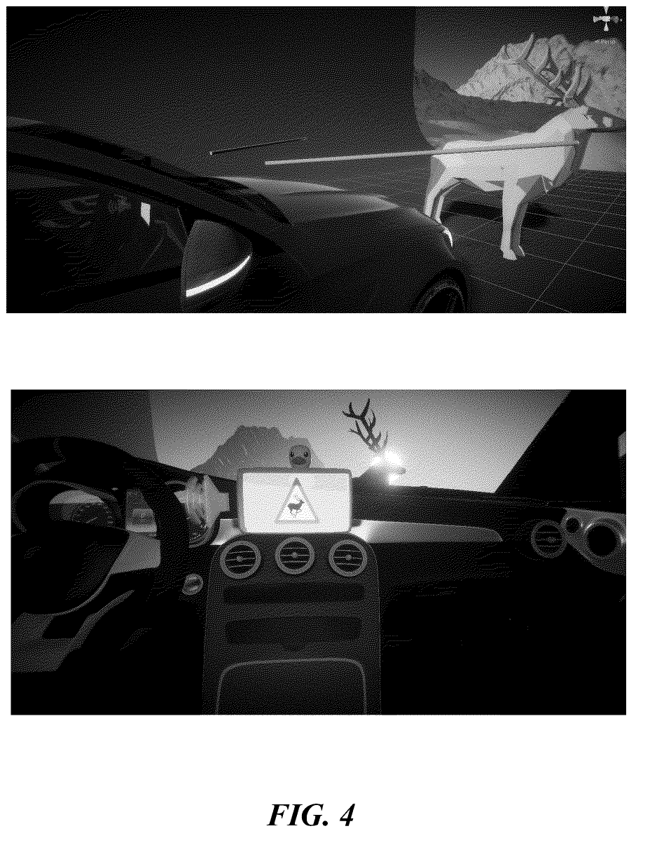

In some embodiments, the alert signal comprises light, audio, or both. In some embodiments, the alert signal comprises an LED light. In some embodiments, the LED light is red, yellow, blue, or green. In some embodiments, the LED light is a strip or a single LED. In some embodiments, the alert signal is a human-readable symbol. For example, FIG. 4 shows an alert signal displayed through a screen when an animal is detected in close proximity to the vehicle.

In some embodiments, the alert signal is directional to indicate a direction that the animal is detected in.

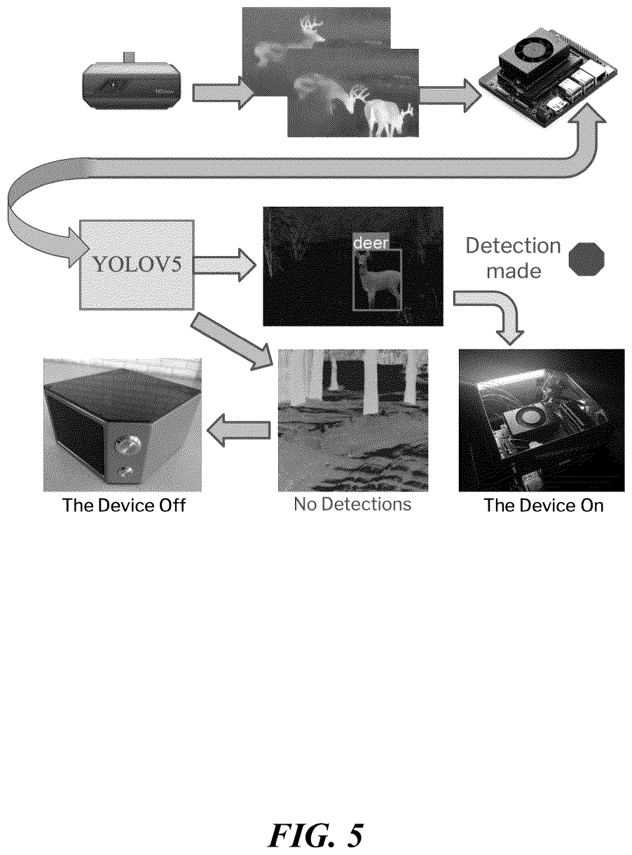

FIG. 5 shows a decision-model for generating or not generating an alert signal when an animal is detected, in accordance with some embodiments. A thermal camera can take thermal images. The thermal images can be processed by a neural network using a graphical processing unit. The neural network can output that an animal is detected, or that an animal is not detected. When the animal is detected, an alert signal can be generated. When the animal is not detected, no alert signal may be generated.

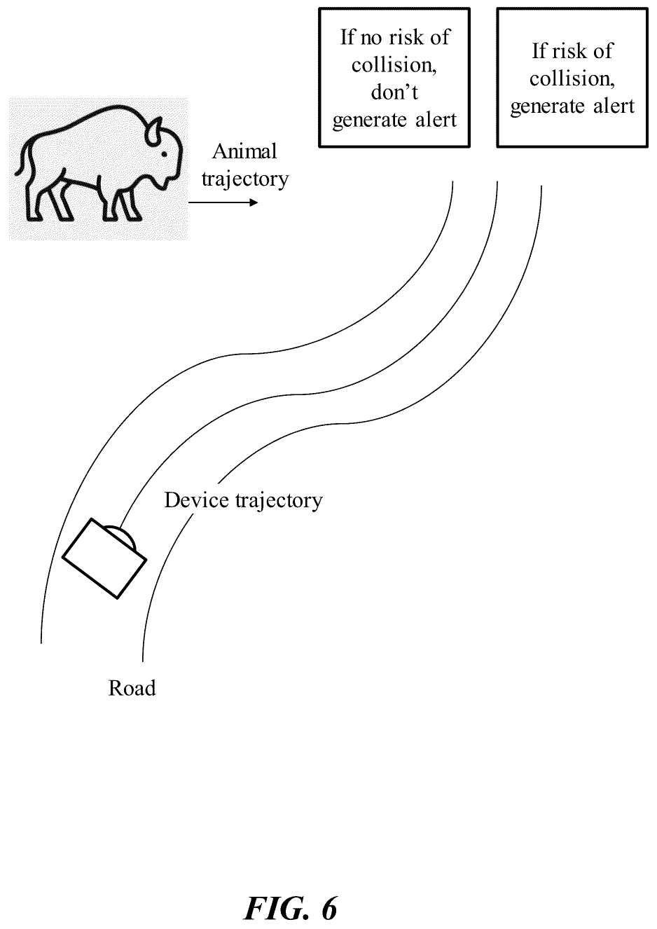

FIG. 6 shows a decision-model for generating or not generating an alert signal when an animal is detected, in accordance with some embodiments. In some embodiments, the alert signal is generated when the risk of collision is significant, e.g., above a predetermined threshold. In some embodiments, the alert signal is not generated when the risk of collision is insignificant, e.g., below a predetermined threshold. The predetermined threshold can be less than 1, 2, 3, 4, or 5 percent. The predetermined threshold can be greater than 1, 2, 3, 4, or 5 percent. In some embodiments, the intensity of the alert signal varies based on risk of collision, proximity to the animal, or both. In some embodiments, the alert signal comprises a light that blinks with higher frequency when the risk of collision is high or the animal is close compared to when the risk of collision is low or the animal is far. In some embodiments, the alert signal comprises a sound that is louder when the risk of collision is high or the animal is close compared to when the risk of collision is low or the animal is far. In some embodiments, the alert signal comprises a sound that beeps with higher frequency when the risk of collision is high or the animal is close compared to when the risk of collision is low or the animal is far. In some embodiments, the alert signal comprises a recording of a human voice.

### Data Privacy

In some aspects, the present disclosure provides a device. In some embodiments, the device comprises a camera comprising a field of view. In some embodiments, the device comprises a processor. In some embodiments, the processor comprises computer-executable instructions. In some embodiments, the computer-executable instructions are configured to process, using a neural network, a plurality of images obtained from the camera to detect an animal within the field of view. In some embodiments, the computer-executable instructions are configured to generate an alert signal indicating that the animal was detected. In some embodiments, the device is configured to delete images in 60 seconds or less. In some embodiments, the processor is configured to delete images in 30, 15, 10, 5, 3, 2, 1 seconds or less. In some embodiments, the device is configured to delete images in 60 seconds or more. In some embodiments, the processor is configured to delete images in 30, 15, 10, 5, 3, 2, 1, 0 seconds or more. In some embodiments, the neural network is contained within the device. In some embodiments, the neural network is on the cloud.

### Microcomputer and Power

In some embodiments, the device comprises an external power source. In some embodiments, the external power source comprises a plug. In some embodiments, the device comprises an internal power source. In some embodiments, the device comprises a battery. In some embodiments, the battery is a lithium-ion battery. In some embodiments, the battery is a lithium metal battery. In some embodiments, the internal power source comprises a voltage regulator. In some embodiments, the processor comprises a graphical processing unit. In some embodiments, the processor comprises a central processing unit.

Various protocols may be used to communicate between components and subsystems of the device. For example, GPIO can be used to communicate with the warning module. USB can be used to communicate with the camera. Ribbon cable connections can be used for cameras. Other options are available.

In some embodiments, the processor comprises firmware configured to perform hardware acceleration. In some embodiments, the computer-executable instructions further comprise a crash sequence that autonomously runs when the computer-executable instructions crash. In some embodiments, the computer-executable instructions further comprise a boot sequence that autonomously runs when the device is turned on. In some embodiments, the computer-executable instructions further comprise a power saving sequence configured to detect that a vehicle that the device is mounted to is not running or not moving. In some embodiments, the computer-executable instructions further comprise a power saving sequence configured to reduce power consumption of the device. In some embodiments, the computer-executable instructions are further configured to convert video data into the plurality of images. In some embodiments, the computer-executable instructions are further configured to resize, normalize, or noise filter the plurality of images.

### Mount and Footprint

In some embodiments, the device comprises a mount configured to affix the device within a cabin of a vehicle. In some embodiments, the device comprises a mount configured to affix the device outside a cabin of the vehicle.

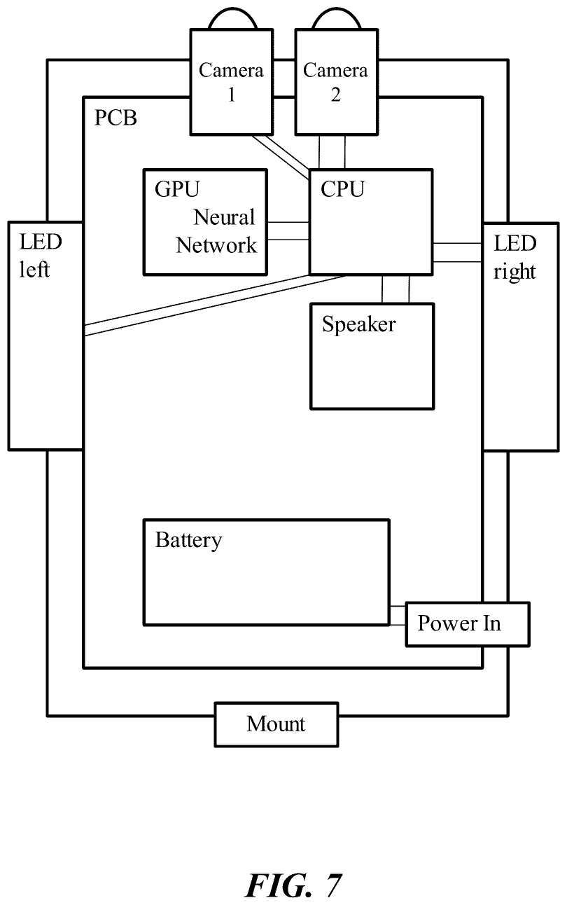

FIG. 7 shows components of the device, in accordance with some embodiments. The device can comprise two cameras or more. The images from the cameras can be directed to a CPU (or directly to a GPU). The images can be preprocessed, then analyzed with a neural network. When an animal is detected, a signal can be generated from a speaker and one or both of the two LEDs which can indicate a direction that the animal was detected in. The device can have a mount, which can be an adhesive, or a coupling to another mechanism that is affixed to the vehicle. The device can comprise a case or a packaging. The case can be configured to provide thermoregulating properties.

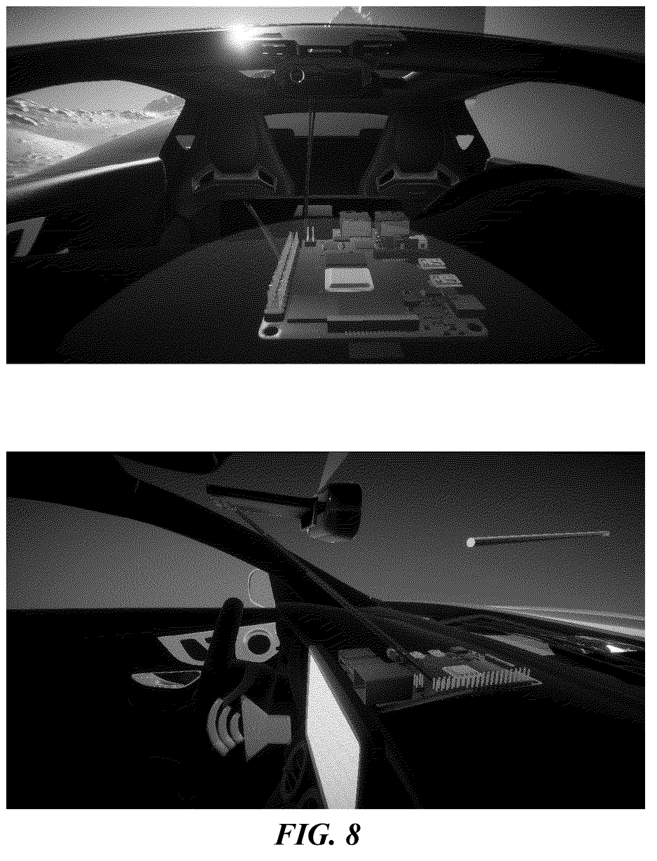

In some embodiments, the device comprises a footprint of less than 50, 40, 30, 20, 10, or 5 cm². In some embodiments, the device comprises a footprint of greater than 50, 40, 30, 20, 10, 5, or 0 cm². In some embodiments, the device comprises a volume of less than 100, 80, 70, 60, 50, 40, 30, 20, or 10 cm³. In some embodiments, the device comprises a volume of greater than 100, 80, 70, 60, 50, 40, 30, 20, 10, or 0 cm³. In some embodiments, the device does not comprise a touchscreen, which can allow the device to be smaller. FIG. 8 shows a device affixed to the dashboard and behind the rearview mirror of a vehicle. The camera and the circuit can be affixed at different locations. The camera can be affixed behind the rearview mirror, on the top of the dashboard, or on the window. The camera and the circuit can be comprised into a unitary device. The device can be affixed behind the rearview mirror, on the top of the dashboard, or on the window.

### Road Hazards

In some embodiments, the computer-executable instructions are further configured to detect a road hazard comprising a tree, a boulder, a bicyclist, a pothole, a construction worker, or any combination thereof. In some embodiments, the animal is a deer, a possum, a dog, a cat, a cow, a squirrel, a rabbit, a skunk, a raccoon. In some embodiments, the neural network is configured to detect a deer, a possum, a dog, a cat, a cow, a squirrel, a rabbit, a skunk, a raccoon, or any combination thereof.

### Computing System

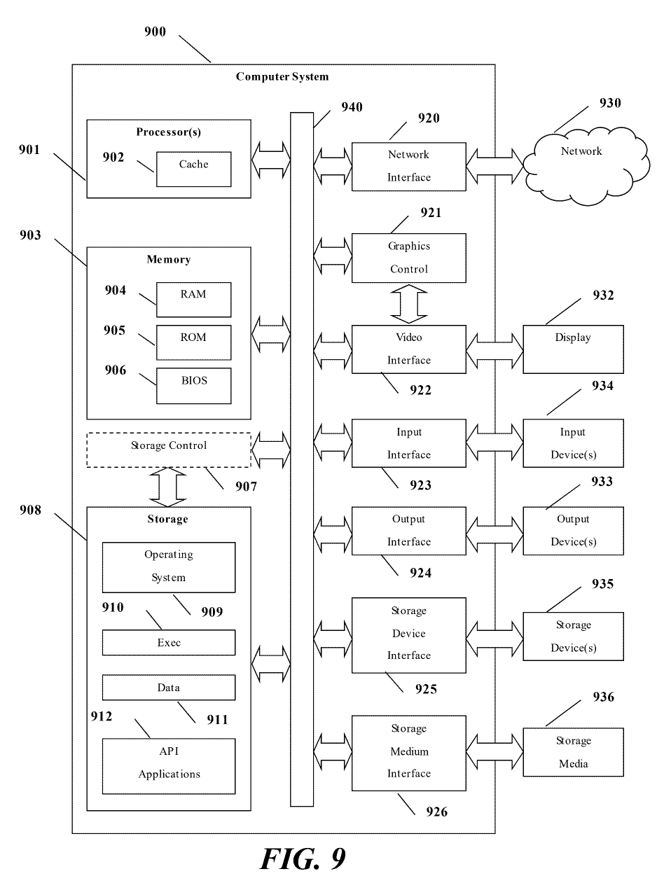

In some aspects, the present disclosure describes a computer-implemented system comprising: a digital processing device comprising: at least one processor, an operating system configured to perform executable instructions, a memory, and a computer program including instructions executable by the digital processing device to detect a road hazard, e.g., an animal. In some aspects, the present disclosure describes a computer-implemented method, implementing any one of the methods disclosed herein in a computer system. Referring to FIG. 9, a block diagram is shown depicting an exemplary machine that includes a computer system 900 (e.g., a processing or computing system) within which a set of instructions can execute for causing a device to perform or execute any one or more of the aspects and/or methodologies for detecting a road hazard. The components in FIG. 9 are examples only and do not limit the scope of use or functionality of any hardware, software, embedded logic component, or a combination of two or more such components implementing particular embodiments.

Computer system 900 may include one or more processors 901, a memory 903, and a storage 908 that communicate with each other, and with other components, via a bus 940. The bus 940 may also link a display 932, one or more input devices 933 (which may, for example, include a keypad, a keyboard, a mouse, a stylus, etc.), one or more output devices 934, one or more storage devices 935, and various tangible storage media 936. All of these elements may interface directly or via one or more interfaces or adaptors to the bus 940. For instance, the various tangible storage media 936 can interface with the bus 940 via storage medium interface 926. Computer system 900 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 900 includes one or more processor(s) 901 (e.g., central processing units (CPUs), general purpose graphics processing units (GPGPUs), or quantum processing units (QPUs)) that carry out functions. Computer system 900 may be one of various high performance computing platforms. For instance, the one or more processor(s) 901 may form a high performance computing cluster. In some embodiments, the one or more processors 901 may form a distributed computing system connected by wired and/or wireless networks. In some embodiments, arrays of CPUs, GPUs, QPUs, or any combination thereof may be operably linked to implement any one of the methods disclosed herein. Processor(s) 901 optionally contains a cache memory unit 902 for temporary local storage of instructions, data, or computer addresses. Processor(s) 901 are configured to assist in execution of computer readable instructions. Computer system 900 may provide functionality for the components depicted in FIG. 9 as a result of the processor(s) 901 executing non-transitory, processor-executable instructions embodied in one or more tangible computer-readable storage media, such as memory 903, storage 908, storage devices 935, and/or storage medium 936. The computer-readable media may store software that implements particular embodiments, and processor(s) 901 may execute the software. Memory 903 may read the software from one or more other computer-readable media (such as mass storage device(s) 935, 936) or from one or more other sources through a suitable interface, such as network interface 920. The software may cause processor(s) 901 to carry out one or more processes or one or more steps of one or more processes described or illustrated herein. Carrying out such processes or steps may include defining data structures stored in memory 903 and modifying the data structures as directed by the software.

The memory 903 may include various components (e.g., machine readable media) including, but not limited to, a random access memory component (e.g., RAM 904) (e.g., static RAM (SRAM), dynamic RAM (DRAM), ferroelectric random access memory (FRAM), phase-change random access memory (PRAM), etc.), a read-only memory component (e.g., ROM 905), and any combinations thereof. ROM 905 may act to communicate data and instructions unidirectionally to processor(s) 901, and RAM 904 may act to communicate data and instructions bidirectionally with processor(s) 901. ROM 905 and RAM 904 may include any suitable tangible computer-readable media described below. In one example, a basic input/output system 906 (BIOS), including basic routines that help to transfer information between elements within computer system 900, such as during start-up, may be stored in the memory 903.

Fixed storage 908 is connected bidirectionally to processor(s) 901, optionally through storage control unit 907. Fixed storage 908 provides additional data storage capacity and may also include any suitable tangible computer-readable media described herein. Storage 908 may be used to store operating system 909, executable(s) 910, data 911, applications 912 (application programs), and the like. Storage 908 can also include an optical disk drive, a solid-state memory device (e.g., flash-based systems), or a combination of any of the above. Information in storage 908 may, in appropriate cases, be incorporated as virtual memory in memory 903.

In one example, storage device(s) 935 may be removably interfaced with computer system 900 (e.g., via an external port connector (not shown)) via a storage device interface 925. Particularly, storage device(s) 935 and an associated machine-readable medium may provide non-volatile and/or volatile storage of machine-readable instructions, data structures, program modules, and/or other data for the computer system 900. In one example, software may reside, completely or partially, within a machine-readable medium on storage device(s) 935. In another example, software may reside, completely or partially, within processor(s) 901.

Bus 940 connects a wide variety of subsystems. Herein, reference to a bus may encompass one or more digital signal lines serving a common function, where appropriate. Bus 940 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 900 may also include an input device 933. In one example, a user of computer system 900 may enter commands and/or other information into computer system 900 via input device(s) 933. Examples of an input device(s) 933 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 933 may be interfaced to bus 940 via any of a variety of input interfaces 923 (e.g., input interface 923) including, but not limited to, serial, parallel, game port, USB, FIREWIRE, THUNDERBOLT, or any combination of the above. In some embodiments, an input device 933 may be used to detect a road hazard.

In particular embodiments, when computer system 900 is connected to network 930, computer system 900 may communicate with other devices, specifically mobile devices and enterprise systems, distributed computing systems, cloud storage systems, cloud computing systems, and the like, connected to network 930. Communications to and from computer system 900 may be sent through network interface 920. For example, network interface 920 may receive incoming communications (such as requests or responses from other devices) in the form of one or more packets (such as Internet Protocol (IP) packets) from network 930, and computer system 900 may store the incoming communications in memory 903 for processing. Computer system 900 may similarly store outgoing communications (such as requests or responses to other devices) in the form of one or more packets in memory 903 and communicated to network 930 from network interface 920. Processor(s) 901 may access these communication packets stored in memory 903 for processing.

Examples of the network interface 920 include, but are not limited to, a network interface card, a modem, and any combination thereof. Examples of a network 930 or network segment 930 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 930, may employ a wired and/or a wireless mode of communication. In general, any network topology may be used.

Information and data can be displayed through a display 932. Examples of a display 932 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 932 can interface to the processor(s) 901, memory 903, and fixed storage 908, as well as other devices, such as input device(s) 933, via the bus 940. The display 932 is linked to the bus 940 via a video interface 922, and transport of data between the display 932 and the bus 940 can be controlled via the graphics control 921. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 932, computer system 900 may include one or more other peripheral output devices 934 including, but not limited to, an audio speaker, a printer, a storage device, and any combinations thereof. Such peripheral output devices may be connected to the bus 940 via an output interface 924. Examples of an output interface 924 include, but are not limited to, a serial port, a parallel connection, a USB port, a FIREWIRE port, a THUNDERBOLT port, and any combinations thereof.

In addition, or as an alternative, computer system 900 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, and tablet computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple®

Ios®, Research In Motion® BlackBerry OS®, Google® Android®, Microsoft® Windows Phone® OS, Microsoft® Windows Mobile® OS, Linux®, and Palm® WebOS®.

In some embodiments, a computer system 900 may be accessible through a user terminal to receive user commands. The user commands may include line commands, scripts, programs, etc., and various instructions executable by the computer system 900. A computer system 900 may receive instructions to detect a road hazard, or schedule a computing job for the computer system 900 to carry out any instructions.

### Non-Transitory Computer Readable Storage Medium

In some aspects, the present disclosure describes a non-transitory computer-readable storage media encoded with a computer program including instructions executable by one or more processors to detect a road hazard using any one of the methods disclosed herein. In some embodiments, a non-transitory computer-readable storage media may comprise instructions for detecting a road hazard. In some embodiments, the platforms, systems, media, and methods disclosed herein include one or more non-transitory computer readable storage media encoded with a program including instructions executable by the operating system of an optionally networked computing device.

In further embodiments, a computer readable storage medium is a tangible component of a computing device. In still further embodiments, a computer readable storage medium is optionally removable from a computing device. In some embodiments, a computer readable storage medium includes, by way of non-limiting examples, flash memory devices, solid state memory, magnetic disk drives, magnetic tape drives, optical disk drives, distributed computing systems including cloud computing systems and services, and the like. In some embodiments, the program and instructions are permanently, substantially permanently, semi-permanently, or non-transitorily encoded on the media.

### Computer Program

In some aspects, the present disclosure describes a computer program product comprising a computer-readable medium having computer-executable code encoded therein, the computer-executable code adapted to be executed to implement any one of the methods disclosed herein. In some embodiments, the platforms, systems, media, and methods disclosed herein include at least one computer program, or use of the same.

A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages. In some embodiments, APIs may comprise various languages, for example, languages in various releases of TensorFlow, Theano, Keras, PyTorch, or any combination thereof which may be implemented in various releases of Python, Python3, C, C#, C++, MatLab, R, Java, or any combination thereof.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information about training a neural network. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### List of Embodiments

The following list of embodiments of the invention are to be considered as disclosing various features of the invention, which features can be considered to be specific to the particular embodiment under which they are discussed, or which are combinable with the various other features as listed in other embodiments. Thus, simply because a feature is discussed under one particular embodiment does not necessarily limit the use of that feature to that embodiment.

Embodiment 1. A device comprising: a thermal imaging camera comprising a field of view; a processor comprising computer-executable instructions configured to: i. process, using a neural network, a plurality of images obtained from the thermal imaging camera to detect an animal within the field of view; and ii. generate an alert signal indicating that the animal was detected.

Embodiment 2. The device of Embodiment 1, wherein the thermal imaging camera is configured to detect infrared radiation.

Embodiment 3. The device of Embodiment 1 or 2, wherein the thermal imaging camera is configured to detect light having wavelengths of at least 780 nm, 800 nm, 850 nm, 900 nm, 950 nm, 1 μm, 5 μm, 10 μm, 50 μm, 100 μm, or 500 μm.

Embodiment 4. The device of any one of Embodiments 1-3, wherein the thermal imaging camera is configured to detect light having wavelengths of at most 800 nm, 850 nm, 900 nm, 950 nm, 1 μm, 5 μm, 10 μm, 50 μm, 100 μm, 500 μm, or 1 mm.

Embodiment 5. A device comprising: a first camera comprising a first field of view; a second camera comprising a second field of view; a processor comprising computer-executable instructions configured to: i. process, using one or more neural networks, a first image from the first field of view of the first camera and a second image from the second field of view of the second camera to detect an animal; ii. determine a position of the animal relative to the device based on the first image and the second image; and iii. generate an alert signal indicating that the animal was detected.

Embodiment 6. The device of Embodiment 5, wherein the first camera and the second camera are configured with different focal lengths.

Embodiment 7. The device of Embodiment 5 or 6, wherein the position of the animal is determined based on the different focal lengths.

Embodiment 8. The device of any one of Embodiments 5-7, wherein the first camera and the second camera are configured to detect different wavelengths of light.

Embodiment 9. The device of any one of Embodiments 5-8, wherein the first camera is a thermal imaging camera.

Embodiment 10. The device of any one of Embodiments 5-9, wherein the second camera have is a visible light camera.

Embodiment 11. The device of any one of Embodiments 5-10, wherein the computer-executable instructions are further configured to convert a first video data from the first camera into a first plurality of images comprising the first image.

Embodiment 12. The device of any one of Embodiments 5-11, wherein the computer-executable instructions are further configured to convert a second video data from the second camera into a first plurality of images comprising the second image.

Embodiment 13. The device of any one of Embodiments 5-13, wherein the computer-executable instructions are further configured to align the first plurality of images and the second plurality of images in time.

Embodiment 14. The device of any one of Embodiments 5-14, wherein the one or more neural networks comprises a first neural network configured to process the first plurality of images.

Embodiment 15. The device of any one of Embodiments 5-15, wherein the one or more neural networks comprises a second neural network configured to process the second plurality of images.

Embodiment 16. The device of any one of Embodiments 5, wherein the first camera and the second camera are configured with the same focal length.

Embodiment 17. The device of Embodiment 16, wherein the position of the animal is determined using parallax based on a first position of the first camera and a second position of the second camera.

Embodiment 18. The device of Embodiment 16 of 17, wherein the first camera and the second camera are configured to detect the same wavelengths of light.

Embodiment 19. The device of any one of Embodiments 5-18, wherein the first camera and the second camera are both a thermal imaging camera.

Embodiment 20. A device comprising: a camera comprising a field of view; a processor comprising computer-executable instructions configured to: i. process, using a neural network, a plurality of images obtained from the camera to detect an animal within the field of view; and ii. generate an alert signal indicating that the animal was detected, wherein the device is configured to delete images in 60 seconds or less.

Embodiment 21. The device of Embodiment 20, wherein the processor is configured to delete images in 30, 15, 10, 5, or 3 seconds or less.

Embodiment 22. The device of Embodiment 20 or 21, wherein the neural network is contained within the device.

Embodiment 23. The device of Embodiment 20 or 21, wherein the neural network is on the cloud.

Embodiment 24. A device comprising: a camera comprising a field of view; a processor comprising computer-executable instructions configured to: i. process, using a neural network, a plurality of images obtained from the camera to detect an animal within the field of view; ii. determine a first trajectory of the animal and a second trajectory of the device; iii. predict a potential collision based on a first trajectory and the second trajectory; and iv. generate an alert signal indicating the potential collision.

Embodiment 25. The device of any one of Embodiments 1-24, further comprising a mount configured to affix the device within a cabin of a vehicle.

Embodiment 26. The device of any one of Embodiments 1-25, wherein the device comprises a footprint of less than 50, 40, 30, 20, 10, or 5 cm2.

Embodiment 27. The device of any one of Embodiments 1-26, wherein the device comprises a volume of less than 100, 80, 70, 60, 50, 40, 30, 20, or 10 cm3.

Embodiment 28. The device of any one of Embodiments 1-27, wherein the device does not comprise a touchscreen.

The device of any one of Embodiments 1-28, further comprising Embodiment 29. an external power source.

Embodiment 30. The device of any one of Embodiments 1-28, further comprising an internal power source.

Embodiment 31. The device of Embodiment 30, further comprising a battery.

Embodiment 32. The device of Embodiment 31, wherein the battery is a lithium-ion battery.

Embodiment 33. The device of Embodiment 31, wherein the battery is a lithium metal battery.

Embodiment 34. The device of any one of Embodiments 1-33, wherein the processor comprises a graphical processing unit.

Embodiment 35. The device of any one of Embodiments 1-34, wherein the processor comprises a central processing unit.

Embodiment 36. The device of any one of Embodiments 1-35, wherein the processor comprises firmware configured to perform hardware acceleration.

Embodiment 37. The device of any one of Embodiments 1-36, wherein the computer-executable instructions further comprise a crash sequence that autonomously runs when the computer-executable instructions crash.

Embodiment 38. The device of any one of Embodiments 1-37, wherein the computer-executable instructions further comprise a boot sequence that autonomously runs when the device is turned on.

Embodiment 39. The device of any one of Embodiments 1-38, wherein the computer-executable instructions further comprise a power saving sequence configured to: a. detect that a vehicle that the device is mounted to is not running or not moving; and b. reduce power consumption of the device.

Embodiment 40. The device of any one of Embodiments 1-39, wherein the computer-executable instructions are further configured to convert video data into the plurality of images.

Embodiment 41. The device of any one of Embodiments 1-40, wherein the computer-executable instructions are further configured to resize, normalize, or noise filter the plurality of images.

Embodiment 42. The device of any one of Embodiments 1-41, wherein the neural network is coded in a low-level language.

Embodiment 43. The device of Embodiment 42, wherein the low-level language is C++ or C.

Embodiment 44. The device of any one of Embodiments 1-43, wherein the neural network comprises a convolutional neural network.

Embodiment 45. The device of any one of Embodiments 1-44, wherein the neural network detects the animal with an accuracy of at least 70, 80, 90, 95, 96, 97, 98, 99, 99.1, 99.2, 99.3, 99.4, 99.5, 99.6, 99.7, 99.8, or 99.9 percent.

Embodiment 46. The device of any one of Embodiments 1-45, wherein the computer-executable instructions are further configured to: a. divide up each image in the plurality of images into a grid of tiles; b. predict a bounding box of the animal based on the grid of tiles; and c. predict a class probability of the animal based on the bounding box.

Embodiment 47. The device of any one of Embodiments 1-46, wherein the neural network is trained to detect the animal using a training dataset of images comprising: a. training images taken during day, night, dawn, dusk, or any combination thereof; and b. training images taken during rain, snow, hail, fog, storm, sunny weather, cloudy weather, or any combination thereof.

Embodiment 48. The device of any one of Embodiments 1-47, wherein the neural network is configured to detect the animal in less than 5000, 4000, 3000, 2000, 1000, 500, 400, 300, 200, 100, 50, 40, 30, 20, or 10 milliseconds when the animal is within 100, 90, 80, 70, 60, 50, 40, 30, 20, or 10 feet of the device.

Embodiment 49. The device of any one of Embodiments 1-48, wherein the plurality of images are processed using an ensemble of neural networks.

Embodiment 50. The device of Embodiment 49, wherein the ensemble of neural networks provide different predictions.

Embodiment 51. The device of Embodiment 50, wherein the computer-executable instructions are further configured to detect the animal based on a consensus between the ensemble of neural networks.

Embodiment 52. The device of any one of Embodiments 1-51, wherein the computer-executable instructions are configured to detect the animal without requiring on a GPS signal.

Embodiment 53. The device of any one of Embodiments 1-52, wherein the computer-executable instructions are configured to detect the animal continuously without disabling detection based on a location of device.

Embodiment 54. The device of any one of Embodiments 1-53, wherein the plurality of images are obtained a rate of at least 1, 2, 3, 4, 5, 6, 7, 8, 9, 10, 20, 30, 40, 50, 60, 80, 90, or 100 times per second.

Embodiment 55. The device of any one of Embodiments 1-54, wherein the camera comprise a resolution of 100, 200, 300, 400, 500, 1000, 2000, 3000, 4000, or 5000 pixels in a first dimension and 100, 200, 300, 400, 500, 1000, 2000, 3000, 4000, or 5000 pixels in a second dimension.

Embodiment 56. The device of any one of Embodiments 1-55, further comprising a lidar or a radar.

Embodiment 57. The device of any one of Embodiments 1-56, wherein the computer-executable instructions are further configured to detect a road hazard comprising a tree, a boulder, a bicyclist, or any combination thereof.

Embodiment 58. The device of any one of Embodiments 1-57, wherein the animal is a deer, a possum, a dog, a cat, a cow, a squirrel, a rabbit, a skunk, a raccoon.

Embodiment 59. The device of any one of Embodiments 1-58, wherein the neural network is configured to detect a deer, a possum, a dog, a cat, a cow, a squirrel, a rabbit, a skunk, a raccoon, or any combination thereof.

Embodiment 60. The device of any one of Embodiments 1-59, wherein the alert signal comprises light, audio, or both.

Embodiment 61. The device of any one of Embodiments 1-60, wherein the alert signal comprises an LED light.

Embodiment 62. The device of Embodiment 61, wherein the LED light is red, yellow, or green.

Embodiment 63. The device of Embodiment 61 or 62, wherein the LED light is a strip or a single LED.

Embodiment 64. The device of any one of Embodiments 1-63, wherein the alert signal is directional to indicate a direction that the animal is detected in.

Embodiment 65. The device of any one of Embodiments 1-64, wherein an intensity of the alert signal varies based on risk of collision, proximity to the animal, or both.

Embodiment 66. The device of any one of Embodiments 1-65, wherein the alert signal comprises a light that blinks with higher frequency when the risk of collision is high or the animal is close compared to when the risk of collision is low or the animal is far.

Embodiment 67. The device of any one of Embodiments 1-66, wherein the alert signal comprises a sound that is louder when the risk of collision is high or the animal is close compared to when the risk of collision is low or the animal is far.

Embodiment 68. The device of any one of Embodiments 1-67, wherein the alert signal comprises a sound that beeps with higher frequency when the risk of collision is high or the animal is close compared to when the risk of collision is low or the animal is far.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the present disclosure may be employed in practicing the present disclosure. It is intended that the following claims define the scope of the present disclosure and that methods and structures within the scope of these claims and their equivalents be covered thereby.

### EXAMPLES

The following examples are provided to further illustrate some embodiments of the present disclosure, but are not intended to limit the scope of the disclosure; it will be understood by their exemplary nature that other procedures, methodologies, or techniques known to those skilled in the art may alternatively be used.

### Example 1: Device for Detecting Animals

This example describes a device that was built to detect animals by using a convolutional neural network to process images from a thermal imaging camera.

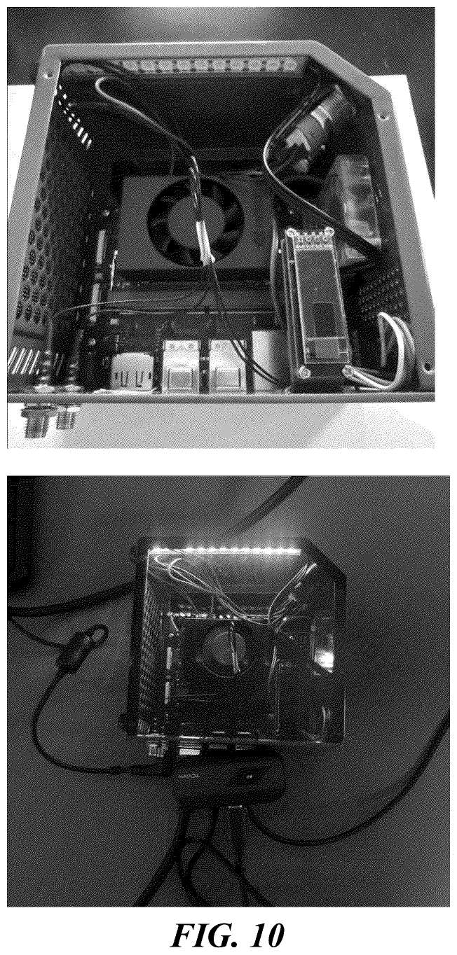

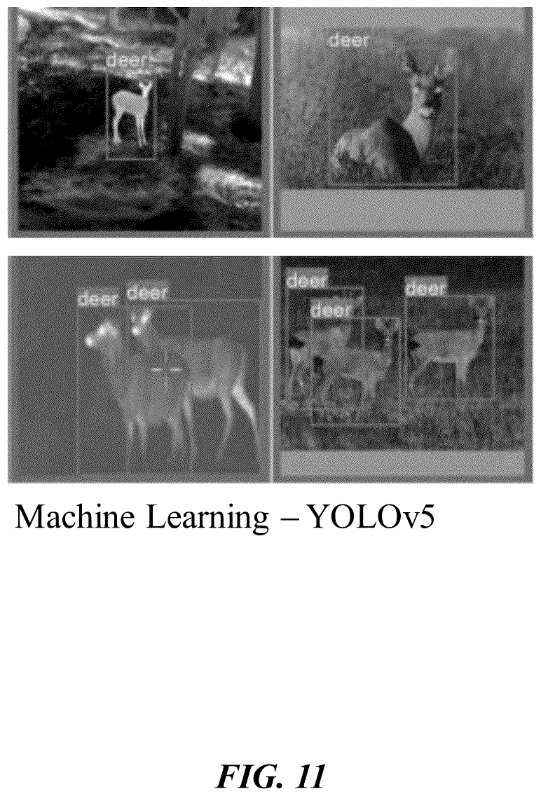

FIG. 10 shows the device. The top panel shows the device while it is not powered. The bottom panel shows the device outputting an alert signal. An NVIDIA Jetson Nano Orin was used as a microcomputer. The microcomputer was wired to a yellow LED and a speaker which were configured to generate a signal when the convolutional neural network detects wildlife from images from the thermal imaging camera. The neural network was a (You Only Look Once) YOLO convolutional neural network stored in the memory of the microcomputer's GPU that continuously analyzed the images taken by the thermal imaging camera. FIG. 11 shows an example of an input image labeled with annotated bounding boxes for animal detection by the neural network. The neural network was trained using a training dataset of deer in various settings. Python was used to implement the neural network in the microcomputer.

### Example 2: Improvements to a Device for Detecting Animals

This example describes improvements that can be made to the device for animal detection.

First, the neural network (and more broadly, the code) is implemented on a low-level language, such as C or C++. The neural network is programmed to analyze images multiple times a second. Computational speed of the neural network is increased with hardware acceleration.

A training dataset is composed of images of various wildlife (e.g., deer, rabbit, possum, raccoon, etc.), in various lighting conditions (e.g., sunny, cloudy, dark, dusk/dawn, rain, snow, hail, partially lit by a vehicle's headlight, etc.). The training dataset can be used so that animal detection accuracy is at least 90%.

The camera system has two or more cameras. The two cameras have different focal lengths which can aid in relative distance determination of an animal. The two cameras can also be used to determine relative distance with parallax. The two cameras can also detect light at different wavelengths.

The alert signals are directional. In other words, the alert signals can indicate not only the presence of an animal, but a direction or a position of the animal. Directional alert signals can be generated by, e.g., a directional light.

The neural network can be an ensemble of neural networks. The ensemble of neural networks can analyze the images and provide different predictions. The different predications can be aggregated to form a consensus. The consensus can be formed, e.g., by a vote. For example, the consensus may require three out of four most recent model runs match a verdict to change the verdict.

The neural network can use posture or pose estimation to detect an animal. 3D Posture or pose estimation can rely on identifying joints in an object and comparing to known joint structure from a dataset. FIG. 3 shows an example of image detection using posture estimation. The neural network is able to detect animals in less than 350 ms.

FIG. 7 shows components of the device, in accordance with some embodiments. The device can comprise two cameras or more. The images from the cameras can be directed to a CPU (or directly to a GPU). The images can be preprocessed, then analyzed with a neural network. When an animal is detected, a signal can be generated from a speaker and one or both of the two LEDs which can indicate a direction that the animal was detected in. The device can have a mount, which can be an adhesive, or a coupling to another mechanism that is affixed to the vehicle. The device can comprise a case or a packaging. The case can be configured to provide thermoregulating properties.

### Example 3: Neural Network Processing

This example describes neural network processing of thermal videos to detect animals.

Inputs to the model are thermal videos taken from the thermal camera, which are processed into images for the model to analyze. The videos are first split into individual frames (images), which are then resized and normalized to meet the input requirements of the model. Noise reduction techniques (such as scaling, blurring, etc.) may also be applied to enhance the clarity and contrast in the thermal images.

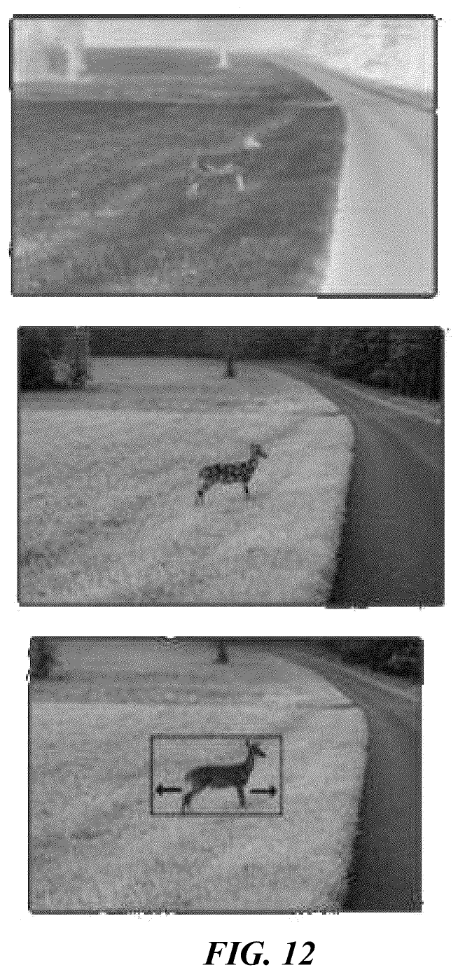

If a dual-camera system is used, then thermal and regular images can be processed separately at first, and then aligned based on frame numbers or timestamps. The input would change to both optical and thermal images for the model to process. Using a dual-camera system involves using two different models to ensure that the two different types of images are processed appropriately according to their unique characteristics. The thermal images are analyzed by a model specifically trained on thermal data, while the visible light images are analyzed by a separate model trained on visible-spectrum data. FIG. 12 shows an example of a thermal image (top) and an optical image (middle). The two different image modalities may be used by a neural network to detect an animal.

The inputs are analyzed in a deep learning-based object detection model (specifically YOLO), a convolutional neural network, which is well-suited for fast image analysis tasks. After the videos are pre-processed into images, the YOLO model processes each frame individually to identify animals that the model was trained on. YOLO works by dividing the image into a grid and predicting bounding boxes and class probabilities for each region of the image.

The model outputs a Boolean value or a confidence value and region (e.g., bounding box with parameters such as confidence and classification) for animal detection. The outputs of the model can be passed through a criteria layer to be analyzed using ensemble or consensus algorithms. The ensemble or consensus algorithms can generate a deterministic output. In addition, the outputs may be used to determine if a region is worth providing a warning or perform further analysis on the source frame, subsequent frames, or other interfaces (such as a narrower focal length camera).

The model is fine-tuned from YOLO. The model is trained with supervised learning, where labeled image data (with bounding boxes and class labels) are used to teach the model to recognize and locate animals. During training, the model adjusts its internal weights to minimize the difference between its predictions and the ground truth annotations. The training process involves feeding batches of images through the network, computing the loss (usually the combination of localization and classification errors), and updating the weights. This process is repeated over multiple epochs until the model reaches satisfactory performance in detecting the target classes with high accuracy and consistency.

The training data is obtained from open source datasets and thermal image repositories, e.g., from Roboflow, Colorado Department of Transportation, Mississippi Department of Wildlife, Fisheries, and Parks, and LILA BC New Zealand Wildlife Thermal Imaging set. The training data is pre-processed. All images used are annotated with bounding boxes around the animals to identify the location of animals in each frame and facilitate supervised learning during the training process. Additional pre-processing steps include resizing images to match the model's input dimensions, normalizing pixel values, and applying data augmentation techniques such as horizontal flipping, brightness adjustment, and rotation. These steps help improve the model's ability to detect animals across various different environments, lighting conditions, and viewpoints.

The model is validated using a hold-out validation set that contains images not seen during training. This ensures that the model's performance is assessed on data it has not memorized, providing a more accurate measure of its ability. Key performance metrics such as precision, recall, F1-score, and mean Average Precision (mAP) are calculated to evaluate how well the model detects animals. The validation set includes a range of environmental conditions (varied lighting, angles, and backgrounds) to determine whether the model is able to perform in any condition possible. Validation results are used to guide hyperparameter tuning and prevent overfitting during training.

### Example 4: Device Source Code

This example provides the source code of a device, in accordance with some embodiments:

```
import cv2
import time
import yolov5.bretect as detect
from CubeNanoLib import CubeNano
gubble = CubeNano (i2c_bus=7)
cam = cv2.VideoCapture (0)
cv2.namedWindow (“test”)
img_name = “opencv_frame.png”
# Note: Images are taken approximately 1/25s (0.04s)
while True:
  ret, frame = cam.read ( )
  if not ret:
    print (“failed to grab frame”)
    break
  cv2.imshow (“test”, frame)
  k = cv2.waitKey (1)
  frame.resize ([frame.shape [ 0 ] / /2, frame.shape [ 1 ],
  frame.shape [ 2 ]])
  if k == 27:
    # ESC pressed
    print (“Escape hit, closing . . .”)
    break
  cv2.imwrite (img_name, frame)
  res =
detect.run (imgsz=(416, 416), conf_thres=0.8, weights=“./weights.pt”,
source=“./”+img_name, nosave=True)
  if res == 1:
      gubble.set_Single_Color (255, 255, 255, 0)
  else:
      gubble.set_Single_Color (0, 0, 0, 0)
  print (res)
cam.release ( )
cv2.destroyAllWindows ( )
```

What is claimed is:

1. A device comprising:
a. a thermal imaging camera comprising a field of view;
b. a processor comprising computer-executable instructions configured to:
i. process, using a neural network, a plurality of images obtained from the thermal imaging camera to detect an animal within the field of view; and
ii. generate an alert signal indicating that the animal was detected.

2. The device of claim 1, further comprising a mount configured to affix the device within a cabin of a vehicle.

3. The device of claim 2, wherein the device comprises a footprint of less than 10 cm2.

4. The device of claim 1, wherein the computer-executable instructions are configured to determine a position of the animal relative to the device based on the first image and the second image.

5. The device of claim 1, wherein the device is configured to delete images in 60 seconds or less.

6. The device of claim 1, wherein the processor comprises a graphical processing unit.

7. The device of claim 1, wherein the neural network is coded in a low-level language.

8. The device of claim 1, wherein the neural network detects the animal with an accuracy of at least 90 percent.

9. The device of claim 8, wherein the neural network is trained to detect the animal using a training dataset of images comprising:
a. training images taken during day, night, dawn, dusk, or any combination thereof; and
b. training images taken during rain, snow, hail, fog, storm, sunny weather, cloudy weather, or any combination thereof.

10. The device of claim 1, wherein the neural network is configured to detect the animal in less than 500 milliseconds when the animal is within 50 feet of the device.

11. The device of claim 1, wherein the plurality of images are obtained a rate of at least 5 times per second.

12. The device of claim 1, wherein the computer-executable instructions are configured to process, using an ensemble of neural networks comprising the neural network, the plurality of images obtained from the thermal imaging camera to detect the animal within the field of view.

13. The device of claim 1, wherein the neural network is configured to detect a deer, a possum, a dog, a cat, a cow, a squirrel, a rabbit, a skunk, a raccoon, or any combination thereof.

14. The device of claim 1, wherein the alert signal comprises light, audio, or both.

15. The device of claim 14, wherein the alert signal comprises an LED light.

16. The device of claim 15, wherein the LED light is red, yellow, or green.

17. The device of claim 1, wherein an intensity of the alert signal varies based on risk of collision, proximity to the animal, or both.

18. The device of claim 1, further comprising a second camera comprising a second field of view, wherein a second plurality images obtained from the second camera in the second field of view is used to detect the animal.

19. The device of claim 18, wherein the second plurality images is used to determine a position of the animal relative to the device.

20. The device of claim 19, wherein the second camera detects different wavelengths from the thermal imaging camera, or wherein the second camera comprises a different focal point from the thermal imaging camera.
